(19) United States
(12) Patent Application Publication
(10) Pub. No.: US 2005/0093366 A1
(43) Pub. Date: May 5, 2005

(54) Brake monitoring system

(75) Inventors: Terry Elstad, Portland, OR (US); Robert Skinner, Lebanon, OR (US); Mark Walker, Hillsboro, OR (US)

Correspondence Address: IAN F. BURNS & ASSOCIATES, 1575 DELUCCHI LANE, SUITE 222, RENO, NV, 89502, US

(73) Assignee: Jerry A. Edwards, Portland, OR (US)

(21) Appl. No.: 10/979,435

(22) Filed: Nov. 1, 2004

Related U.S. Application Data
(60) Provisional application No. 60/516,237, filed on Oct. 31, 2003.
(60) Provisional application No. 60/516,212, filed on Oct. 31, 2003.
(60) Provisional application No. 60/584,974, filed on Jul. 2, 2004.

(51) Int. Cl. B60T 13/00

(52) U.S. Cl. 303/7

(57) ABSTRACT

The present invention comprises a brake monitoring system. The monitoring system includes an auxiliary braking device, the auxiliary braking device configured to activate a braking system of a towed vehicle. The monitoring system also includes a transmitter unit including a transmitter, the transmitter configured to transmit a signal indicating that the braking system of the towed vehicle has been activated. A receiver unit is also included. The receiver unit includes a receiver, the receiver configured to receive the signal transmitted by the transmitter. The monitoring system also includes an indicator in communication with the receiver unit. Activation of the indicator informs a driver of a towing vehicle that the braking system of the towed vehicle has been activated.

### CROSS REFERENCE TO RELATED APPLICATIONS

This application claims priority of provisional U.S. patent applications having Ser. Nos. 60/516,237 and 60/516,212, each filed Oct. 31, 2003, and 60/584,974, filed on Jul. 2, 2004. These applications are hereby expressly incorporated by reference in their entireties.

### FIELD OF THE INVENTION

The present invention relates to monitoring systems and devices for auxiliary braking devices. In particular, the present invention relates to monitoring devices and systems for auxiliary brake systems including auxiliary braking devices that may be used for stopping or slowing down vehicles being towed.

### BACKGROUND

In some situations, when a vehicle is being towed, the towed vehicle relies on the braking system of the towing vehicle for stopping or slowing down. This situation typically produces undue stress on the towing vehicle's braking system. As a result, the life span of the towing vehicle's braking system could be significantly shortened. For instance, the brake pads of the towing vehicle could wear out faster. This situation may pose a risk that the towing vehicle will lose its brakes, perhaps causing an accident.

Furthermore, significant stress on the vehicle connection system, such as the hitch, may result when the towing vehicle stops or slows down the towed vehicle. If stress exceeds the structural strength of the hitch, catastrophic failure of the hitch may result. In such an event, the towed vehicle may become decoupled from the towing vehicle.

Auxiliary braking systems have been developed to try to solve these problems. Some jurisdictions require the use of auxiliary braking systems, especially when the vehicle being towed is heavy. One auxiliary brake system is generally described in Latham (U.S. Pat. No. 5,954,164). Latham essentially utilizes a weighted pendulum attached to the towed vehicle. When the towing vehicle and the towed vehicle decelerate, the inertia of the weighted pendulum will generally cause the pendulum to swing toward the brake pedal of the towed vehicle so as to apply the brakes of the towed vehicle.

At least one potential problem with the brake system in Latham is that different vehicles may require different brake pedal force or pressure to efficiently actuate their brakes and thus require different pendulum weights. A user of the braking system of Latham might find that the pendulum weight included with the purchase is incompatible with the type of vehicle the user has.

An auxiliary braking system that allows the user to adjust the range of force that may be applied to the towed vehicle's brake pedal is desired. For instance, a single auxiliary braking system that would stop or decelerate vehicles of different weight, such as both a light compact car and a large heavy van, is desirable.

Another possible problem with the brake system in Latham is that the weighted pendulum does not allow much room for control. Once the pendulum is set in motion, there appears no way of slowing it down or controlling the force or pressure exerted by the pendulum on the brake pedal. Therefore, an auxiliary braking system is desired that could be more controllable than the pendulum-based braking system of Latham.

A brake controller for use in a towed vehicle to control the application of the towed vehicle's brakes is disclosed purportedly in Hensley (U.S. Pat. No. 6,050,649). The brake controller essentially consists of an optical coupler that senses the movement of the brake pedal of the towing vehicle by a graduated increase in transmitted light, or by counting marks associated with a spring-tensioned cable or chain secured between the tow vehicle firewall and the brake pedal arm. The optical coupler appears to produce a brake control signal, which is representative of the desired braking of the towed vehicle. The optical coupler generally sends the brake control signal in the form of a current flow to a micro-controller to generate an output signal for actuating the electric brakes of the towed vehicle.

At least one possible problem with the brake controller in Hensley is that it completely relies on an electric-based drive mechanism. Electric-based drive mechanisms, such as the brake controller of Hensley, have a high power requirement, which may drain the battery of the towed vehicle, if used at a power source over a period of time.

Another potential disadvantage is that the Hensley system is dependent on an input from the towing vehicle's brake pedal to actuate the towed vehicle's brakes. In the event communication between the system sensor and the micro-controller is lost, the braking system could be unable to actuate the towed vehicle's brakes. This could result in excessive wear on the brakes of the towing vehicle; in the failure of the linkage between the towed and towing vehicle; and/or in safety concerns due to inadequate braking power. It would be beneficial to provide a device in the towed vehicle that initiates braking of the towed vehicle. In addition, it would be beneficial to provide a device that automatically activates the brakes in the towed vehicle upon failure of the linkage between the towed and towing vehicle.

Another possible issue with the electrically powered auxiliary brake system like the Hensley invention is that a loss of electrical power during the brake activation by the electric powered system could improperly leave the brake system activated. This unwanted braking of the towed vehicle during the towing could result in possible damage and resulting brake failure for the towed vehicle.

Yet another potential problem for the electrically powered auxiliary brake system like the Hensley system could be the possible accidental and unwanted activating of the brake system through a fault in the brake light system of the towing vehicle. Some vehicles have a brake light system that combines brake light with parking or riding light in one bulb, like the 1157 brake/riding light bulb. This type of bulb has two filaments, one that is energized for the brake light and one that is energized for the parking or running light. If the running light filament is broken while the running lights are on, it is possible for the energized portion of the broken running light filament to make contact with and energize the brake light filament. In this manner, the brake light circuit could become energized. If the Henley system is electrically connected to the brake light system of a towing vehicle that has a combined brake/running light system, the accidental energizing of the brake light system could result in unwanted activation of the auxiliary braking system/towed vehicle's braking system, resulting in possible damage to or failure of the towed vehicle's braking system.

A brake actuation system for towed vehicles is also disclosed in Harner, et al. (U.S. Publication number 2002/0030405, hereinafter “Harner”). Harner discloses a brake controller that transmits a variable voltage, which in turn causes an electromagnet to produce a strong magnetic field. The magnetic field causes a steel sheave to rotate, which then urges arms or knuckles to rotate. This causes an actuating cable that is secured to the tow vehicle brake pedal to move.

In addition to the problems identified above for electric-based drive mechanisms, the brake actuation system in Hamer et al. is intrusive. For instance, the user has to open the hood of the towed vehicle to install the Hamer brake controller and to connect the system with the master brake cylinder of the towed vehicle. As one of ordinary skill may appreciate, the brake actuation system of Hamer et al. requires substantial labor and time to install. The brake actuation system also uses a vacuum source that is directly connected to the master brake cylinder of the towed vehicle. Using a vacuum source may be problematic. First, the connection itself must be airtight; any leaks in the connection will cause the braking system of the towed vehicle to fail. Second, the use of vacuum mandates extensive maintenance. Third, a loss of vacuum in the master brake cylinder may cause the braking system of the vehicle with the Hamer brake actuation system installed therein to fail. Finally, Hamer et al.'s system may not be compatible with, or may interfere with, the operation of at least some anti-lock braking systems (ABS).

Another vacuum actuated towed vehicle brake actuation system is described in Shuck (U.S. Pat. No. 6,158,823). Shuck discloses an electrically-controlled, vacuum-operated brake actuation system. The brake actuation system uses a towing vehicle's brake light to control the activation and deactivation of the brake actuation system for the towed vehicle. At least one disadvantage of this system is that the braking force applied to the brake pedal of the towed vehicle cannot be controlled. Because the system described in Shuck is also vacuum operated, Shuck's system also suffers from the disadvantages of Harner et al.'s system described above.

Additionally, as described for the Hensley system, if the Shuck system is electrically connected to the brake light system of a towing vehicle that utilizes a dual filament bulb for a combined brake/running light system, an electrical short or fault in the dual filament bulb could accidentally cause the unwanted activation of the Shuck auxiliary braking system/towed vehicle's braking system leading to possible damage to/failure of the towed vehicle's braking system.

Another brake control system is disclosed in Greaves, Jr. (U.S. Pat. No. 6,280,004). The braking system in Greaves, Jr. has two switches to control the actuation of the towed vehicle's brakes. One switch is a brake switch that is closed when the user depresses a brake pedal to actuate the brake of a towing vehicle and the other switch is a microswitch positioned in proximity to the tow hitch such that the microswitch is closed when the towed vehicle exerts a forward pressure against the towing vehicle.

Similar to the system disclosed in Shuck, the brake control system disclosed in Greaves, Jr. is controlled by connecting the brake control system to the brake light of the towing vehicle. Thus, Greaves, Jr. suffers from the disadvantages of Shuck's system described above, such as incompatibility with ABS systems and lack of control on the force being exerted on the towed vehicle's brake pedals. Greaves, Jr.'s system is also intrusive because it taps into the brake lines. Furthermore, the microswitch activation requires a considerable amount of play in the tow hitch assembly. Because of the amount of required play, the Greaves, Jr.'s microswitch activation may not work with some hitch assemblies having low tolerances or minimal play.

Additionally, as described for the Hensley and Shuck's supplementary braking system, if the Greaves, Jr.'s supplementary brake system is electrically connected to the brake light of a towing vehicle that utilizes dual filament bulb for a combined brake/running light system, an electrical short or fault in the dual filament bulb could accidentally cause the unwanted activation of the Greaves, Jr.'s auxiliary braking system/towed vehicle's braking system leading to possible damage to/failure of the towed vehicle's braking system.

What has long been needed is an auxiliary braking system that does not suffer from at least some of the disadvantages stated above.

### SUMMARY

Advantages of One or More Embodiments of the Present Invention

The various embodiments of the present invention may, but do not necessarily, achieve one or more of the following advantages:
the ability to use a magnetic field to control a brake pedal of a vehicle being towed;
provide pressure to the brake pedal of a vehicle being towed with a pressure substantially proportional to a detected amount of deceleration;
provide an auxiliary braking device that is reactive to a change in momentum of the vehicle being towed;
the ability to variably control the pressure being applied to the brake pedal of the vehicle being towed;
provide an auxiliary braking device with little tendency to overheat the brakes of the vehicle being towed;
provide an auxiliary braking device that requires minimal power to operate;
provide an auxiliary braking system that upon a loss of power automatically disengages the system;
provide an auxiliary braking device that does not require tapping into brake lines of the vehicle being towed;
provide a portable auxiliary braking device that may be used for a variety of vehicle types;
provide an auxiliary braking device that may be easily assembled or set-up;
provide an auxiliary braking device that is not likely to void the towed vehicle's warranty;
provide an auxiliary braking device that is compatible with vehicles having ABS braking systems;
the ability to allow braking pressure to be adjusted according to a braking requirement of a vehicle being towed;
provide varying levels of braking power;
provide an indicator to the driver of a towing vehicle that the battery of the towed vehicle is running low;
provide feedback to the driver of the towing vehicle that the braking device for a towed vehicle is functioning correctly;
provide a monitoring system for monitoring the operation of a braking device for a towed vehicle; and
provide a device to alert a driver of a towing vehicle when the braking system of a towed vehicle is not operating properly.

These and other advantages may be realized by reference to the remaining portions of the specification, claims, and abstract.

### BRIEF DESCRIPTION OF EMBODIMENTS OF THE PRESENT INVENTION

The present invention comprises a brake monitoring system. The monitoring system may include an auxiliary braking device, the auxiliary braking device may include an actuator configured to activate a braking system of a towed vehicle brake to slow down or stop a vehicle, a fluid source configured to provide fluid for driving the actuator to activate the vehicle brake; and a fluid regulator capable of at least partially controlling the amount of fluid the actuator uses to drive the vehicle brake. The fluid regulator may include an inlet port in communication with the fluid source and configured to receive fluid from the fluid source and an outlet port to provide an exit for the fluid entering from the inlet port. The fluid regulator may include a valve control mechanism, which is movable from a closed position where the valve control mechanism prevents the fluid from exiting through the outlet port to an open position where the fluid is free to exit. The monitoring system also includes a transmitter unit including a transmitter, the transmitter being configured to transmit a signal indicating that the braking system of the towed vehicle has been activated. A receiver unit is also included. The receiver unit includes a receiver, the receiver being configured to receive the signal transmitted by the transmitter. The monitoring system also includes an indicator, which may include a light, a lamp, a speaker, and the like, in communication with the receiver unit. Activation of the indicator informs a driver of a towing vehicle that the braking system of the towed vehicle has been activated.

The present invention also includes a method for monitoring a braking system that assists a towing vehicle in braking. Fluid is provided to an inlet port of a first regulator. A fluid passage is provided between the inlet port of the first regulator and an outlet port of the first regulator. The fluid passage is blocked with a plunger to prevent the fluid from exiting through the outlet port. A deceleration is detected by measuring the change in momentum of the towing vehicle. The change in momentum in converted to an electrical signal and sent to an electromagnet of the first regulator. The electromagnet displaces the plunger to open the fluid passage and allow the fluid to pass through. The fluid drives an actuator attached to a brake pedal of the towed vehicle thereby causing the actuator to depress the brake pedal and causing the towed vehicle to slow down. In this method, the braking system in a towed vehicle is activated when a towing vehicle is braked. Upon braking, a signal is transmitted from a transmitter in a transmitter unit in the towed vehicle. The signal indicates that the braking system in the towed vehicle has been activated. The signal is received by a receiver in a receiver unit in the towing vehicle. Indication that the braking system in the towed vehicle has been activated is provided to a driver of the towing vehicle.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a side view of a towing vehicle and a towed vehicle having an embodiment of the auxiliary braking device of the present invention installed therein.

FIG. 2 is substantially a schematic diagram of the components of a preferred embodiment of the auxiliary braking device of the present invention.

FIG. 3A is substantially an exploded view of a preferred embodiment of a valve member of the present invention.

FIG. 3B is substantially an exploded view of a preferred embodiment of a valve actuator member of the present invention.

FIG. 4 is substantially a side perspective view of a preferred embodiment of the auxiliary braking device of the present invention.

FIG. 5 is substantially a flow chart of one method of operation of an embodiment of the auxiliary braking device of the present invention.

FIG. 6 is substantially a block diagram of components of an embodiment of the auxiliary brake system.

FIG. 7 is substantially a circuit diagram for a receiver that may be used with certain embodiments of the present invention.

FIG. 8 is substantially a circuit diagram for a transmitter that may be used with certain embodiments of the present invention.

FIG. 9 is substantially a circuit diagram of an embodiment of a controller that may be used with the present invention.

### DESCRIPTION OF THE PREFERRED EMBODIMENTS OF THE PRESENT INVENTION

In the following detailed description of the preferred embodiments, reference is made to the accompanying drawings, which form a part of this application. The drawings show, by way of illustration, exemplary embodiments in which the invention may be practiced. It is to be understood that other embodiments may be utilized and/or structural changes may be made without departing from the scope of the present invention.

As used herein, the term “vehicle” refers to any equipment used to carry or transport objects, including without limitation, mechanized equipment, non-mechanized equipment, automobiles, trailers, recreational vehicles, commercial vehicles, and the like. The term “fluid” is used to refer to a substance tending to flow, including without limitation, a liquid, such as oil, or a gas, such as air. The term “chamber” is used to refer to an enclosed space or cavity and may be interchanged with the term “cylinder.” While the term “cylinder” may refer to a chamber having a cylindrical shape, the cylindrical shape should not be used to limit the term, and a variety of chamber shapes should fall within the scope of the present invention. The applicant utilizes various spatially orienting terms, such as “upper,” “lower,” “horizontal,” and “vertical.” It is to be understood that these terms are used for ease of description of the preferred embodiments with respect to the drawings but are not necessarily in themselves limiting or requiring of an orientation as thereby described.

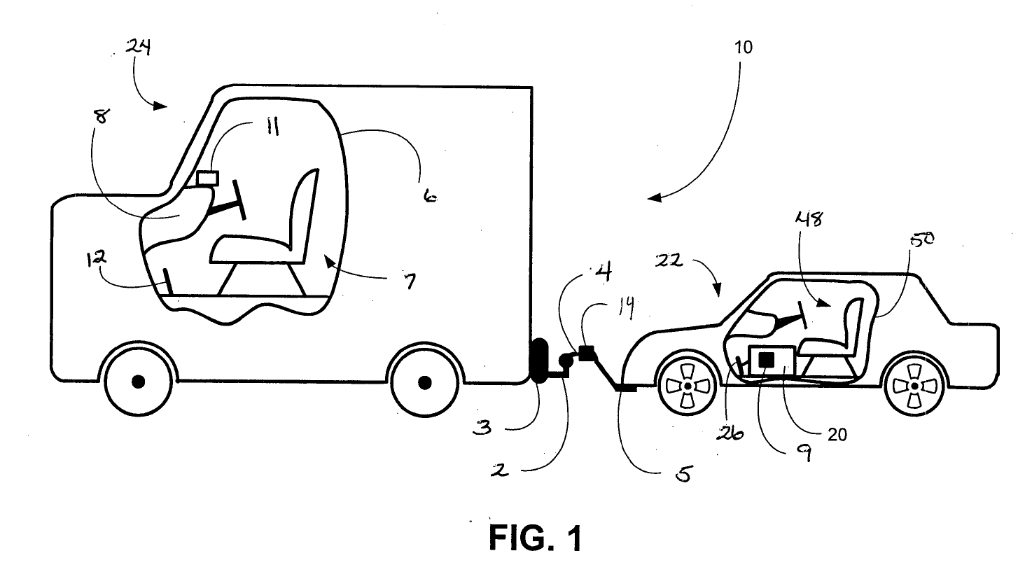

FIG. 1 is substantially a side view of a towing vehicle 24 and a towed vehicle 22 having an embodiment of the auxiliary brake system 10 of the present invention installed therein and used for stopping or slowing down the towed vehicle 22. Auxiliary brake system 10 may further comprise an auxiliary braking device 20 (hereinafter referred to as “ABD”) residing in the towed vehicle 22. Auxiliary brake system 10 may further comprise a receiver unit 11 residing in the towing vehicle 24 and a transmitter unit 9 located in towed vehicle 22. Receiver unit 11 may be integrated into ABD 20 or may be a separate unit, operatively connected with ABD 20. ABD 20 supplements the brake system of a towing vehicle 24 in stopping or slowing down a vehicle being towed 22. In certain embodiments, ABD 20 provides auxiliary braking to towed vehicle 22 by contacting the towed vehicle's brake pedal 26 and depressing brake pedal 26 when appropriate.

Towing vehicle 24 is illustrated as having a towing “ball” 2 coupled to the bumper 3 of towing vehicle 24. A “hitch attachment” 4 is coupled to a suitable structure 5 of the towed vehicle 22. Accordingly, when hitch attachment 4 is coupled to towing ball 2, the towing vehicle 24 tows the towed vehicle 22. Of course, the above-described means of coupling the towing vehicle 24 and the towed vehicle 22 may be effected with any suitable means, and alternative embodiments of the auxiliary brake system 10 may be employed with any such means.

The cut-away line 6 demarks the outside and an inside portion 7 of the towing vehicle 24. For convenience, receiver unit 11 is illustrated as sitting on top of dashboard 8. In one embodiment, receiver unit 11 is affixed to dashboard 8 using a suitable means, such as Velcro, a strap, a bracket or the like. As will be discussed further, receiver unit 11 may, among other things, provide an indication to occupants of the towing vehicle that the auxiliary brake system 10 is functioning as intended and/or is not functioning as intended.

The cut-away line 50 demarks the outside and an inside portion 48 of the towed vehicle 22. For convenience, an ABD 20 is illustrated as sitting on the floor of towed vehicle 22 in front of a driver seat. ABD 20 may comprise adjustable feet 28a on its bottom surface to help position the device. Adjustable feet may be made in various ways that provide for the adjustment of the feet. For example, adjustable feet 28a may comprise threaded rod that allows the feet to be threaded into sockets. By rotating the feet into and out of the socket, the height of the feet may be adjusted. Fee 28a may also be adjusted horizontally to allow ABD to be more easily place on irregularly shaped floors. In one embodiment, ABD 20 is affixed to the floor using means such as Velcro, a strap, a bracket or the like. ABD 20 is coupled to the brake pedal 26 as described herein.

At least one embodiment includes a break away system 14. Break away system 14 is configured to detect separation of towed vehicle 22 from towing vehicle 24, such as during a failure of ball 2 and/or hitch attachment 4. This condition may be communicated to the driver of towing vehicle 24, such as by providing a visible indicator on receiver unit 11.

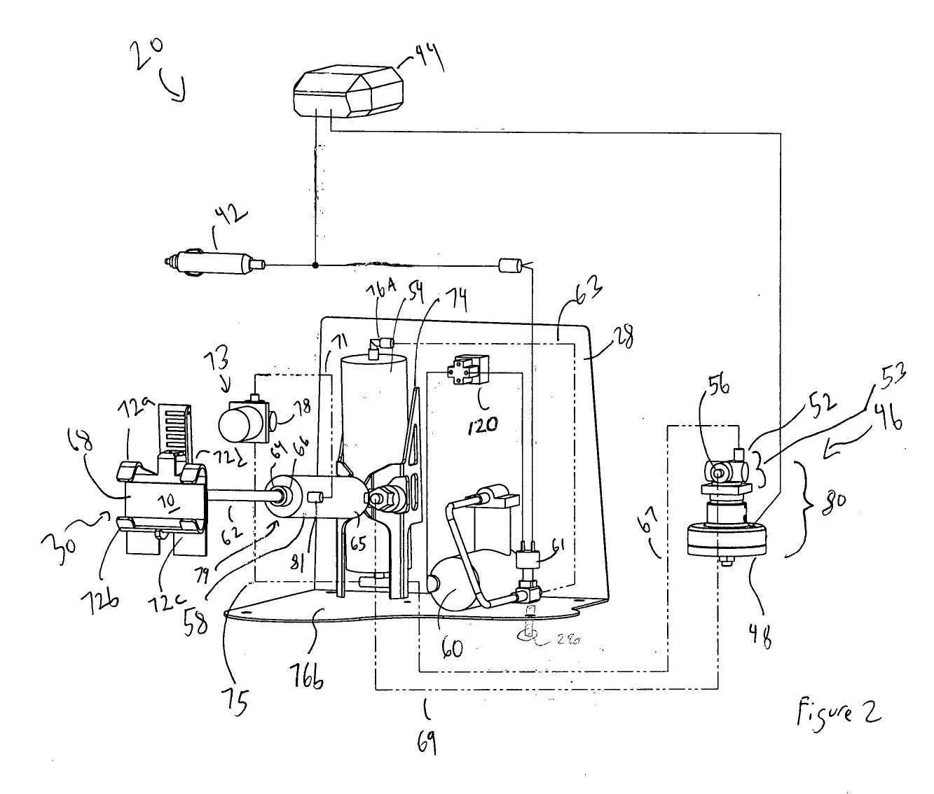

Referring now to FIG. 2, there is shown a schematic diagram illustrating the components of an embodiment of ABD 20. In one embodiment, ABD 20 is powered by a battery (not shown) of vehicle 22. ABD 20 may be connected to the battery through a cigarette lighter adapter 42. In other embodiments, other power sources are employed. For example, an auxiliary battery (not shown) may provide power to ABD 20.

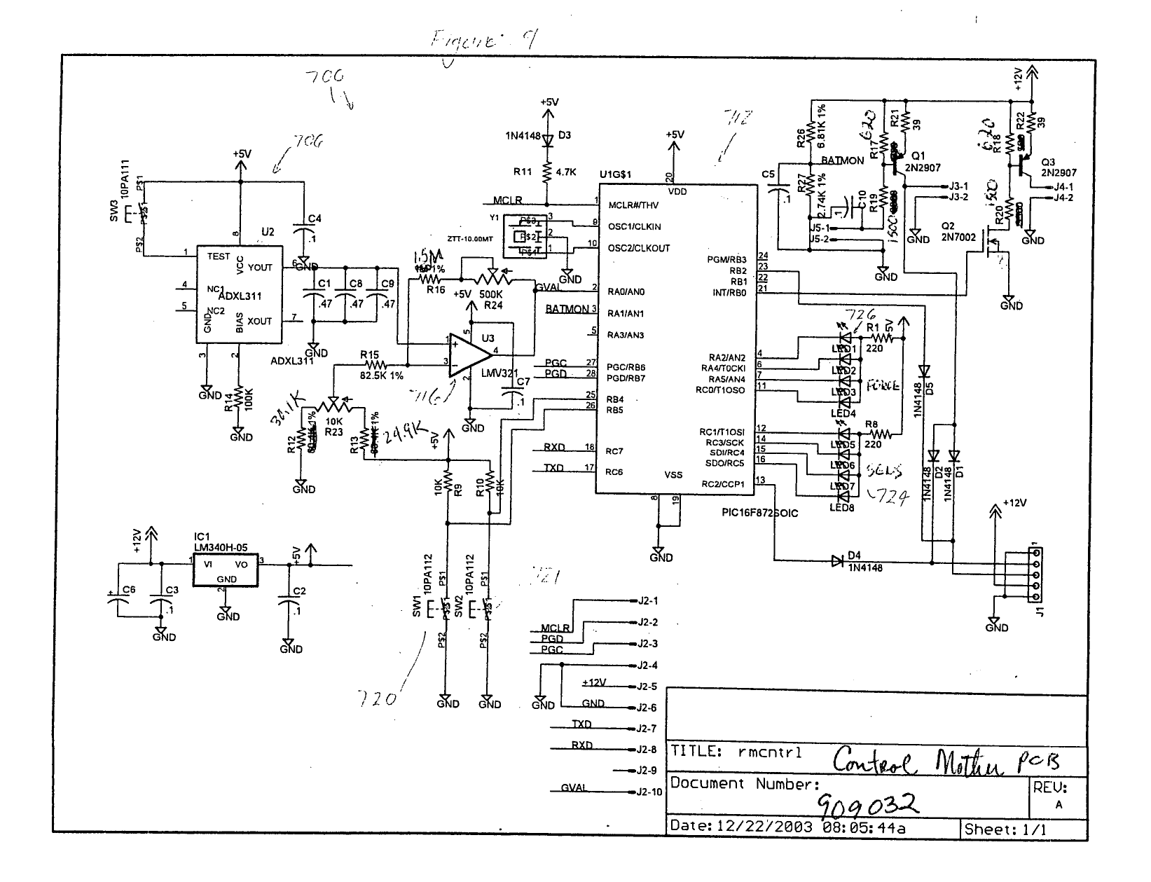

ABD 20 may include a controller 44. Controller 44 may preferably be an inertia sensing device that detects a change in the momentum or velocity of the vehicle being towed and converts the detected deceleration into an electrical signal or an output voltage level. The electrical signal level may be proportional to the deceleration detected by the controller 44. A circuit diagram for one embodiment of a controller 44 is illustrated in FIG. 9, discussed further below.

In at least one embodiment, ABD 20 includes a fluid source. The fluid source may provide air as fluid to ABD 20. As would be apparent to one of skill in the art, other types of fluids may be used, such as various types of gases or liquids.

The fluid source may utilize an air compressor 60 if the fluid is a gas such as air for possibly pressurizing the fluid to possibly provide mechanical power for the invention. In at least another embodiment of the invention where the fluid is a liquid, a pump (not shown) may be substituted for the air compressor 60 to possibly provide the pressurizing of the fluid needed to possibly provide mechanical power for the invention. The air compressor 60 or pump, (not shown) may also be powered by the battery (not shown) of towed vehicle 22 through a cigarette light adapter 42. A relay switch 120 may be provided to efficiently distribute the power from the battery of the towed vehicle. A fluid reservoir 54 may be in fluid communication with air compressor 60 through a first fluid connector 63. Fluid reservoir 54 may be configured to store the fluid received from air compressor 60.

A support frame 74 may be attached to fluid reservoir 54 and ABD housing wall 76a to maintain an upright position of fluid reservoir 54. The bottom portion of air compressor 60 may be fastened directly to ABD housing wall 76b to provide a stable air compressor mounting. Fluid reservoir 54 may be coupled to a first regulator 46 through an inlet port 52 by a second fluid connector 67. Fluid connectors may include tubes, fittings, and fasteners known in the art.

The fluid pressure in fluid reservoir 54 may be regulated by an optional pressure switch 61. Pressure switch 61 turns air compressor 60 on and off depending on pre-determined fluid pressure requirements of the fluid source. The fluid pressure requirement of the fluid source may be a pre-determined optimal pressure necessary for efficient functioning of ABD 20. The fluid pressure in the fluid source may be user-controllable.

Controller 44 may be in electronic communication with first regulator 46 and may be configured to send an electric signal of a particular voltage to first regulator 46. The voltage of the output signal may be proportional to the inertia change sensed by controller 44 as discussed above. The proportional output signal allows breaking to be applied in proportion to the amount of deceleration. First regulator 46 may include a valve member 53 and a valve actuator member 80.

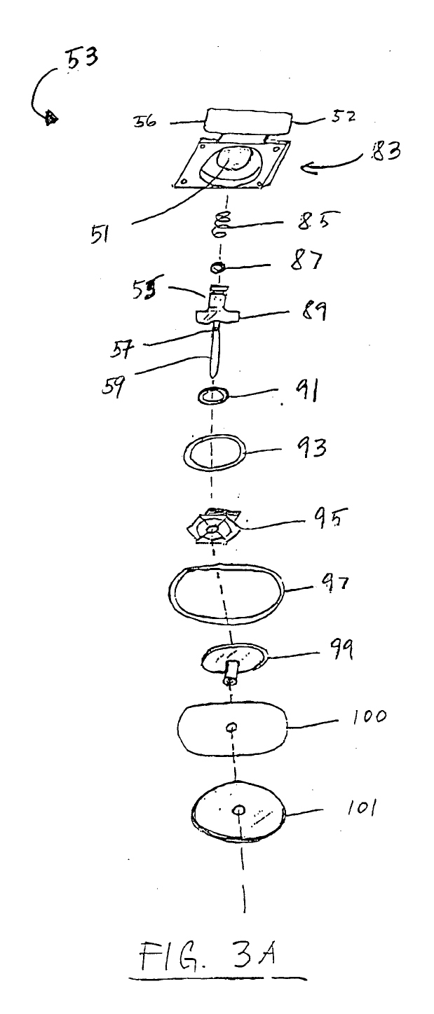

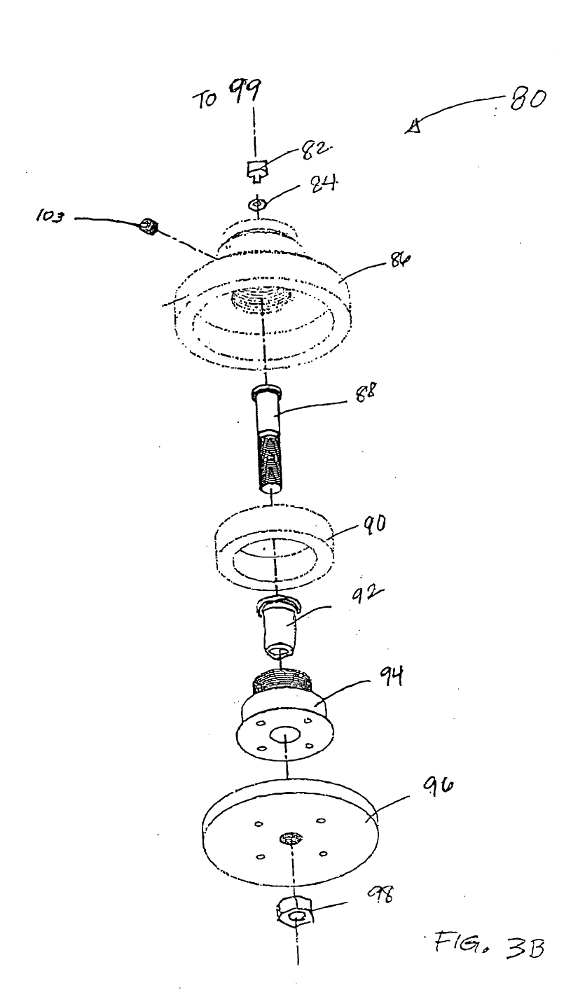

With reference now to FIG. 3A, there is shown an exploded view of valve member 53 of first regulator 46. Valve member 53 may include an inlet port 52 and an outlet port 56 positioned exterior of a valve member housing 83. Within the interior of valve member housing 83, there exists a fluid passage 51 that connects inlet port 52 and outlet port 56. Valve member 53 further includes a plunger 89 configured to be positioned within valve member housing 83 and substantially around fluid passage 51 or in between inlet port 52 and outlet port 56.

Plunger 89 may be configured to move from a closed position, wherein plunger 89 blocks fluid passage 51, to an open position, wherein plunger 89 allows fluid communication between inlet port 52 and outlet port 56, and vice-versa. A plunger retainer spring 85 and a plunger o-ring 87 may be positioned around a first end 55 of plunger 89. Spring 85 may also be any biasing device known in the art, or later developed, and may be configured to bias plunger 89 to be in the closed position and to allow plunger 89 to move between open and closed positions. Plunger 89 may define a vent 57 to prohibit or substantially reduce the risk of vacuum formation within the plunger and housing, thereby allowing plunger 89 to move smoothly.

Around second end 59 of plunger 89, a plunger seal 91, a retaining bolt seal 93, and a retaining bolt 95 may be attached to plunger 89 to ensure that fluid can only exit out of first regulator 53 through outlet port 56. Retaining bolt 95 may be threaded and may be configured to mount plunger 89 and the seals 91 and 93 to valve member housing 83, which may have a threaded end to receive and retain retaining bolt 95. A septum seal 97, a rivet 99, a septum 100, and a septum retainer 101 may be attached to plunger 89 to further ensure that fluid can only exit out of first regulator 53 through outlet port 56. Modifications to the components of valve member 53 may be made that still fall within the scope of the invention. Modifications may include eliminating a component or replacing a component. Valve member 53 may be obtained from Wilkerson Company of Englewood, Colorado.

With reference to FIG. 2 again, valve member 53 may be configured to be attached to valve actuator member 80. Valve member 53 may be coupled to valve actuator member 80 via a threaded bottom portion of valve member 53 and a threaded neck of valve actuator member 80. Other fastener types known in the art may be used to couple valve member 53 and valve actuator member 80. With reference now to FIG. 3B, valve actuator member 80 may be an electromagnet assembly, which causes plunger 89 (FIG. 3A) of valve member 53 (FIG. 3A) to move from the open position to the closed position and vice-versa. Other motors or actuators known in the art, or later developed, may be used as a substitute for the electromagnet assembly.

Valve actuator member 80 may include a valve shaft 88, which is configured to be coupled to rivet 99 (FIG. 3A) and to be indirectly coupled to plunger 89 (FIG. 3A) of valve member 53 (FIG. 3A) via a first bushing 82 and an o-ring 84. Valve shaft 88 may couple an electromagnetic coil 90 and magnetic disc 96, which may be positioned inside an electromagnetic housing 86. A second bushing 92 and a coil adaptor 94 may be inserted in-between coil 90 and valve shaft 88 to snugly position coil 90 onto electromagnetic housing 86 and valve shaft 88. The magnetic disc 96 may be positioned on valve shaft 88 proximate to coil adaptor 94 and coil 90. A nut 98 may be used to secure electromagnetic coil 90, second bushing 92, coil adaptor 94, and magnetic disc 96 to shaft 88. Valve shaft 88 may have an end opposite to the plunger that is threaded to receive nut 98. Valve actuator member 80 may further include a set screw 103 that may be used to hold the coil adapter 94 in place and allow a user to adjust the distance between coil 90 and magnetic disc 96. Set screw 103 may further allow a user to set the range of force for driving the plunger and consequently the range of fluid pressure valve actuator member 80 may be able to generate and transmit.

A wire (not shown) from controller 44 (FIG. 2) may be connected to coil 90 allowing electronic communication between coil 90 and controller 44. An electric signal from controller 44 provides power to coil 90 and activates valve actuator member 80. The activation of valve actuator member 80 causes magnetic disc 96 to move toward housing 86. Because magnetic disc 96 is coupled to shaft 88 and plunger 89 (FIG. 3A), the activation of coil 90 causes the plunger 89 to move to the open position thereby allowing fluid flow from inlet port 52 (FIG. 3A) to output port 56 (FIG. 3A). The degree and time of the opening of the plunger 89 may be controlled by the strength and duration of the electrical signal received by valve actuator member 80, which is dependent on the level and duration of inertial change sensed by the controller 44, as discussed above.

In at least one embodiment, the valve actuator member 80 may be configure so that when plunger 89 blocks the passage between inlet port 52 and outlet port 56, it allows for a connection between outlet port 56 and a relief port (not shown). In this manner, when fluid is not being introduced from outlet port 56 into the fluid chamber 58 via first regulator 46, fluid in the fluid chamber 56, if the fluid is air, could be vented to the outside atmosphere.

Referring back to FIG. 2, output port 56 of first regulator 46 may be coupled to a head 65 of fluid chamber 58 via a third fluid connector 69, which may be made from tubes, fittings, and fasteners known in the art. Output port 56 may be configured to send fluid to fluid chamber 58. Internal pressure within fluid chamber 58 may be built by the flow and the supply of fluid from output port 56 of first regulator 46. In one embodiment, an initial internal pressure may be maintained at approximately 9 pounds per square inch (psi) within fluid chamber 58. Other embodiments may employ other suitable working pressures of the fluids in fluid chamber 58. An increase in internal pressure within fluid chamber 58 caused by a detected deceleration of towed vehicle 22 subsequently actuates brake actuator 30. Brake actuator 30 may include a brake actuator shaft 62 that is moveably coupled to fluid chamber 58. Brake actuator shaft 62 may be configured to slide parallel to a horizontal axis, and a portion of brake actuator shaft 62 may be configured to move in and out of fluid chamber 58.

Fluid chamber 58 may include a shaft passage 64 that is configured to receive brake actuator shaft 62 with a sealably sliding fit, which minimizes the seepage of fluid out of fluid chamber 58. A shaft bushing 66 may be used to provide the sealably sliding fit between brake actuator shaft 62 and fluid chamber 58. Brake actuator shaft 62 may be biased by biasing devices known in the art, or those later developed, such as a spring or fluid pressure directed opposite to the actuating position of shaft 62. Biasing devices bias shaft 62 to a position where it has the tendency to move toward a fluid chamber head 65 and away from the brake pedal 26 (shown in FIG. 1) of the towed vehicle 22 (shown in FIG. 1).

Brake actuator 30 may further include a pedal clamp structure 68 configured to be attachable to brake pedal 26 (FIG. 1) of towed vehicle 22 (FIG. 1). Pedal clamp structure 68 may include a plate 70 attached at an end of brake actuator shaft 62 that is away from fluid chamber head 65. Pedal clamp structure 68 may further include a plurality of fingers 72a-d protruding from plate 70 and bent toward the surface of plate 70 to form a clamp-like structure. Fingers 72 may be made of materials that are the same or similar to the materials used for plate 70 and that are attached substantially perpendicular to plate 70 and that have extensions substantially parallel or at an angle relative to plate 70 to form a clamp-like structure. Plate 70 may be made of multiple pieces that allow plate 70 to extend and retract via a biasing device, such as a spring, thereby providing flexibility to plate 70 in accommodating a variety of brake pedal sizes.

As internal pressure from fluid chamber 58 moves brake actuator shaft 62 away from fluid chamber head 65, brake actuator shaft 62, which is attached to pedal clamp structure 68 configured to be clamped to the towed vehicle's brake pedal, depresses or actuates the brake pedal thereby allowing the towed vehicle to decelerate or stop.

In at least one embodiment, ABD 20 also includes a brake actuator retraction system 79 (hereinafter referred to as “BARS”) configured to retract brake actuator 30 to allow the towed vehicle to accelerate along with the towing vehicle. BARS 79 may include an exhaust port 78 and an exhaust valve (not shown) that is in fluid communication with fluid chamber 58 via a vent port 81 on fluid chamber 58.

BARS 79 may be in communication with controller 44 and may include a second regulator 73. Second regulator 73 may be in communication with fluid reservoir 54. Fluid reservoir 54 may be configured to provide fluid pressure to second regulator 73 and to fluid cylinder 58 through lines 75 and 71 respectively.

Fluid pressure may be received at the end of fluid cylinder 58 that is adjacent to shaft bushing 66 so that fluid preferably travels in the direction toward fluid cylinder head 65 thereby causing actuator 62 to retract. In at least one embodiment, second regulator 73 is configured to supply 7 psi of fluid pressure to fluid cylinder 58 to bias actuator 62 to a retracted position. This pressure may be maintained whenever ABD 20 is active, and must be overcome in order to activate the brakes of the towed vehicle. Accordingly, when a residual pressure, such as the 7 psi, is applied, first regulator 46 must apply the residual pressure in addition to the desired braking pressure in order to apply the desired braking pressure.

Controller 44 is preferably configured to detect a change in momentum of the towed vehicle caused by the acceleration of the towing vehicle 24 (FIG. 1) and convert said change in momentum to an electrical signal. Controller 44 may send the electrical signal to BARS 79 and causes BARS 79 to open exhaust port 78 and vent port 81, thereby allowing fluid from fluid chamber 58 to exit or bleed off. Alternatively, a fluid reservoir (not shown) could be provided to store excess fluid. Such a fluid reservoir would be useful if it is undesirable to bleed of excess fluid, such as if liquid fluids are used.

The internal pressure that extends brake actuator shaft 62 toward the towed vehicle's brake pedal subsequently decreases, thereby allowing brake actuator shaft 62 to retract toward fluid chamber head 65 with the aid of the 7 psi of pressure controlled by second regulator 73. When brake actuator shaft 62 is retracted, the braking power of the towed vehicle is reduced, and towed vehicle 22 may accelerate with towing vehicle 24.

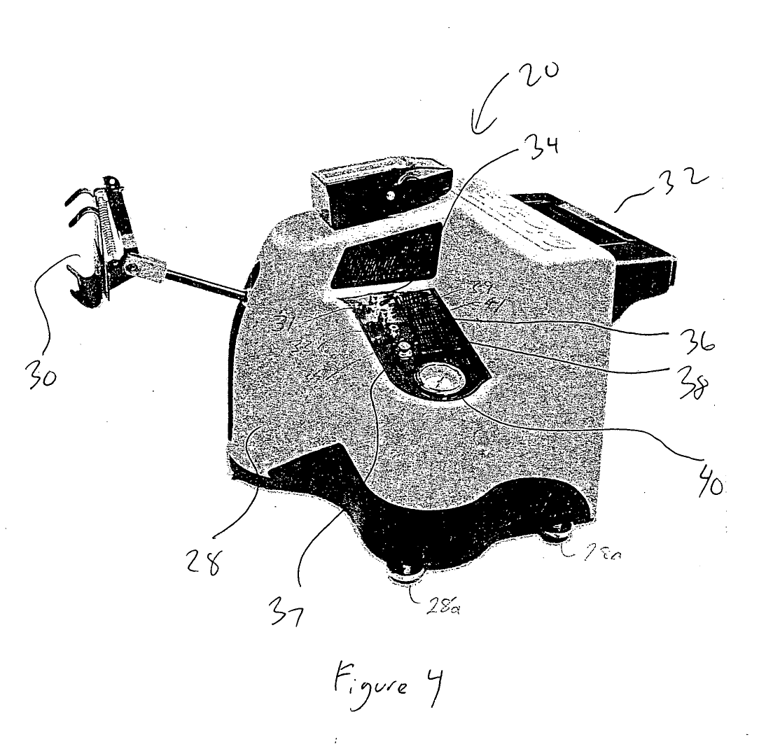

Referring next to FIG. 4, external components of at least one embodiment of ABD 20 are depicted. ABD 20 may comprise a housing 28, which encases the interior components of ABD 20. A brake actuator 30 may protrude from housing 28. Brake actuator 30 may be configured to depress towed vehicle's 22 brake pedal 26 (FIG. 1) when appropriate. A handle 32 may be coupled to housing 28 to allow users to conveniently transport or hold ABD 20.

Housing 28 may comprise buttons, lights, gauges, and connectors to possibly facilitate its operation and coordination with other related devices. Buttons that could be mounted on the housing could include a vent button 31, test button 33, a maximum brake pressure button 35, and a brake sensitivity button 37.

Vent button 31 that could be mounted on the housing 28 may be provided to allow a user to manually bleed or reduce the pressure within one or more components of the invention. Vent button 31 may be particularly useful in releasing any residual pressure within fluid chamber 58 that causes brake actuator 30 to ride on a vehicle's brake pedal, thereby allowing the user to move the vehicle. Vent button 31 may also be used to vent the residual pressure applied by second regulator 73.

A test button 33 that could be mounted on the housing 28 could be used for testing communications between receiver unit 11 and transmitter unit 9 (FIG. 1) of the brake monitoring system. The maximum brake pressure button 35 and a brake sensitivity button 37 that could mounted on the housing 28 could be used simultaneously to calibrate the ABD 20 to the level position of the towed vehicle 22 need for proper operation of the invention.

The maximum brake pressure button 35 and a brake sensitivity button 37 could also be used to set the pressure setting that would dictate the range of pressure brake actuator 30 would be able to supply to towed vehicle's brake pedal 26. The range of pressure brake actuator 30 would supply to brake pedal 26 (FIG. 1) may be based on the brake pedal force required to stop the towed vehicle 22, which may be based on the weight of towed vehicle 22. Other factors may also be considered in determining the range of pressures, such as the braking capacity of towing vehicle 24 or the road surface on which the towing vehicle 24 and towed vehicle 22 will be traveling.

The maximum brake pressure button 35 and a brake sensitivity button 37 could be also possibly be used in conjunction with a set of maximum brake pressure lights 39 and a set of brake sensitivity lights 41, both sets of lights could be mounted on the housing 28. The sets of lights could allow the user to see the pressure settings for invention as maximum brake pressure button 35 and a brake sensitivity button 37 are respectively activated.

In at least one embodiment, a pressure gauge 40 that could be mounted on the housing could be used for indicating fluid pressure of one or more components of the invention could be mounted on the housing 28. The pressure gauge display 40 may be provided and positioned on housing 28 to allow the user to see the pressure setting for brake actuator 30 and to adjust the working pressure of ABD 20.

Connectors could be mounted on the housing 28 could be a set of first attachment points 34 and a second attachment point 36. The set of first attachment points 34 may be configured to receive a monitoring system (not shown). The monitoring system is described further below. A second attachment point 36 may also be positioned on housing 28. Second attachment point 36 may be configured to receive a signal from break away system 14 (FIG. 1) described below.

In one embodiment, a break away system 14 is a device that is connected to the hitch attachment 4 (FIG. 1). In the event towed vehicle 22 (FIG. 1) is separated from towing vehicle 24 (FIG. 1), break away system 14 will generate a signal causing ABD 20 to activate, thereby causing towed vehicle 22 to stop. Break away system 14 may be any suitable device for detecting separation of towed vehicle 22 from towing vehicle 24. The resultant signal indicating a break away condition may be communicated to the ABD 20 in any suitable manner, such as, but not limited to, an RF signal or a signal communicated over wire. The break away condition may then be transmitted to receiver unit 11 and the driver of towing vehicle 24 alerted to the condition.

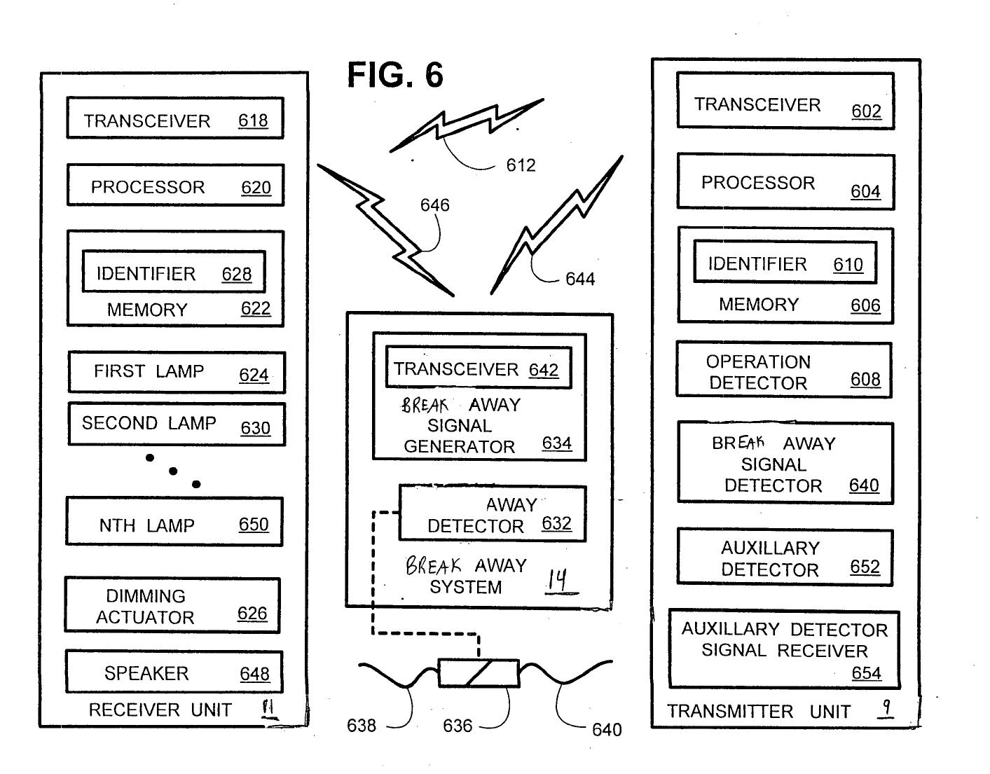

FIG. 6 is a block diagram of components of an embodiment of brake monitoring system 16 (FIG. 1), which includes auxiliary brake system 10 (FIG. 1). Brake monitoring system 16 may include receiver unit 11 and transmitter unit 9. Transmitter unit 9 may reside within ABD 20 (FIG. 1) or may be separate from, but operatively coupled to, ABD 20. This embodiment may include optional break away system 14.

Transmitter unit 9 may include a transceiver 602, processor 604, memory 606, and an operation detector 608. As used herein, a “transceiver” may be a device that may function as both a transmitter and receiver. However, it is to be understood that present invention does not require transceivers and that the transceivers may be replaced by a transmitter or receiver, as appropriate.

A portion of memory 606 may store a suitable identifier 610 that identifies the transmitter unit 9. Operation detector 608 is configured to detect operation of the selected components of ABD 20. If all selected components are properly operating, operation detector 608 communicates a signal to processor 604 indicating proper operation. If one or more of the selected components are not properly operating, a corresponding signal is communicated to processor 604. The signal received from operation detector 608 is processed by processor 604 into a suitable signal that is communicated to transceiver 602. Transceiver 602 broadcasts a corresponding RF signal 612 that is received by the receiver unit 11, thereby indicating that all selected components are operating properly or that one or more selected components are not properly operating.

Receiver unit 11 may include a transceiver 618, processor 620 and memory 622. One embodiment comprises at least a first indicator lamp 624, and a dimming actuator 626. Other components described herein below may be included in other embodiments. RF signal 612 is received by transceiver 618, and a corresponding signal generated by transceiver 618 is communicated to processor 620 for processing.

In one embodiment, part of the received RF signal 612 is the above-described identifier 610 stored in memory 606 that identifies transmitter unit 9. A corresponding identifier 628 is stored in memory 622. The received identifier 610 is compared with the identifier 628 saved in memory 622. If the identifiers 610 and 628 correspond, receiver unit 11 understands that it was the intended recipient of the RF signal 612.

A portion of the received RF signal 612 includes information corresponding to the signal from operation detector 608. In embodiments having first lamp 624, if the selected components in ABD 20 are properly operating, first lamp 624 is illuminated such that a driver of towing vehicle 24 understands that ABD 20 is properly operating. If RF signal 612 includes information indicating that one or more selected components in ABD 20 are not properly operating, a second indicator lamp 630 may be illuminated, indicating that one or more components of ABD 20 are not properly operating. In another embodiment, first lamp 624 is illuminated differently, such as with another color, to indicate to the driver that one or more components of ABD 20 are not properly operating. In at least one embodiment, first lamp 624 (or another lamp) is illuminated every time brake pedal 26 (FIG. 1) in towing vehicle 22 (FIG. 1) is actuated, so long as ABD 20 is operating properly. In this way, the driver of towing vehicle 24 (FIG. 1) is provided with positive feedback concerning the status of ABD 20 every time he or she brakes towing vehicle 22.

In one embodiment, the dimming actuator 626 is employed. When actuated at a first illumination level or brightness, lamp 624 (and other lamps) is illuminated at an intensity that is visible during high ambient light conditions, such as during a bright sunny day. When actuated at a second illumination level or brightness, lamp 624 (and other lamps) is illuminated at an intensity that is visible during low ambient light conditions, such as at nighttime. Dimming actuator 626 may be any suitable controller, such as, but not limited to, a toggle switch, a push button or the like. In embodiments such as those employing a display screen (not shown), the functionality of dimming actuator 626 may be implemented through a menu system.

In embodiments employing break away system 14, transmitter unit 9 includes a break away signal detector 632 to detect signals from the break away system 14. Break away system 14 may comprise a break away detector 632 and a break away signal generator 634. Break away detector 632 may be any suitable detector or detection system configured to detect separation of towed vehicle 22 from the towing vehicle 24.

For example, one embodiment employs a simple connector 636 that detects physical loss of connectivity between the towed vehicle 22 and the towing vehicle 24. Connector 636 is physically coupled to a suitable location on the towing vehicle 24 with a flexible attachment 638. Attachment 638 may be implemented with a wire, cord, cable, chain, rope, string or other suitable connection means. Flexibility provides for convenient coupling to the towing vehicle 24 and allows for movement during the towing process. Similarly, a flexible attachment 640 provides coupling between the towed vehicle 22 and connector 636. During a separation condition, separation of connector 636 is detected by break away detector 632. Other embodiments may employ more sophisticated separation detector systems.

If break away detector 632 detects separation of towed vehicle 22 from towing vehicle 24, break away signal generator 632 generates a corresponding signal that indicates the separation. Alternatively, the separation may be indicated by the interruption of a signal, such as the interruption of a circuit, a blown fuse, or similar mechanism. The separation signal, or signal interruption, is communicated to break away signal detector 640. In one embodiment of break away signal generator 634, a transceiver 642 is used to generate a first separation signal 644 communicated to transceiver 602 as an RF signal. Upon receiving separation signal 644, the transmitter unit 9 understands the occurrence of a separation event. Accordingly, a braking signal is generated and communicated such that the ABD 20 initiates a braking action of the towed vehicle 22. In one embodiment, the separation signal 644 includes an identifier corresponding to identifier 610 so that other signals received by transceiver 602 do not generate a “false” braking signal.

In one embodiment, transceiver 642 generates a second separation signal 646 as an RF signal. Second separation signal 646 is received by transceiver 618. Upon receiving the second separation signal 646, at least one suitable indicium is communicated such that a driver of the towing vehicle 24 understands that a break away condition has occurred. For example, without limitation, one of the above-described lamps 624, 630 or an Nth indicator lamp 650 may be illuminated. In another embodiment, an audible warning sound may be generated by a speaker 648 or other suitable indicator or sound generating device.

Upon receiving the separation signal, the break away signal detector 640 communicates with processor 604 such that processor 604 initiates a braking action of the towed vehicle 22 in accordance with embodiments of the present invention.

Testing of break away system 14 may be automatically initiated at power up in one embodiment. In another embodiment, the testing may be initiated by the driver by pulling a ring (not shown) on the break away device that simulates a break away, or separation, condition. Another embodiment comprises a test device (not shown) that simulates a separation condition. Lamp 624 remains illuminated until the break away system ring is returned or the test device is reset.

Alternative embodiments of transmitter unit 9 may further comprise one or more auxiliary detectors 652 that detect various conditions of towed vehicle 22 or towing vehicle 24. Other embodiments may include an auxiliary detector signal receiver 654 configured to receive signals from one or more remote detection devices (not shown). For example, conditions of the towed vehicle 22 or towing vehicle 24 may include a satellite dish that is not in a retracted and/or secured position, an electric step that is not retracted, compartments or doors open, or other useful warnings. When such a condition is detected by auxiliary detector 652, and/or when a remote detector (not shown) detects such a condition and communicates a signal to the auxiliary detector signal receiver 654, the condition is indicated to processor 604 via a suitable communication signal. Processor 604 then processes the received signal and causes transceiver 602 to broadcast the detected condition to receiver unit 11 via RF signal 612. When signal 612 indicating the detected condition is received by transceiver 618, a suitable warning indicia is then communicated to the driver of towing vehicle 24. For example, an Nth lamp 650 may be illuminated. In other embodiments, an audible warning signal may be provided.

In one embodiment, receiver unit 11 is configured to recognize that transmitter unit 9 has been replaced with a replacement transmitter unit (not shown) which may be similar to transmitter unit 9. The replacement transmitter unit includes another identifier residing in its memory. Actuating the dimming actuator 626 or another suitable controller, in one embodiment, for a predefined time causes processor 620 to recognize that a new identifier for a replacement transmitter unit is to be received. For example, but not limited to, the dimming actuator 626 is pressed for approximately six seconds to initiate the process of receiving an identifier from a replacement transmitter unit. First lamp 624 may periodically flash indicating that receiver unit 11 is ready to learn new identifiers for the replacement transmitter unit. In another embodiment, lamp 624 may illuminate if no identifiers 628 reside in memory 622, thereby indicating that at least one transmitter unit identifier is needed. Transceiver 618 then receives an RF signal from the replacement transmitter unit such that an identifier corresponding to replacement transmitter unit is saved into memory 622.

Furthermore, in an alternative embodiment, multiple transmitter units (not shown), which may be similar to transmitter unit 9, may be used. This embodiment may be desirable in a situation where multiple towed vehicles 24 are towed by the towing vehicle 22. Or, such an embodiment may be desirable when a fleet of towing vehicles 24 is towing a plurality of different towed vehicles 22 at different times. Accordingly, a plurality of transceiver unit identifiers 628 may be saved into memory 622. When an RF signal 612 is received, the plurality of identifiers are cycled through to see if the identifier in the received RF signal corresponds to one of the currently active identifiers 628 saved in memory 622.

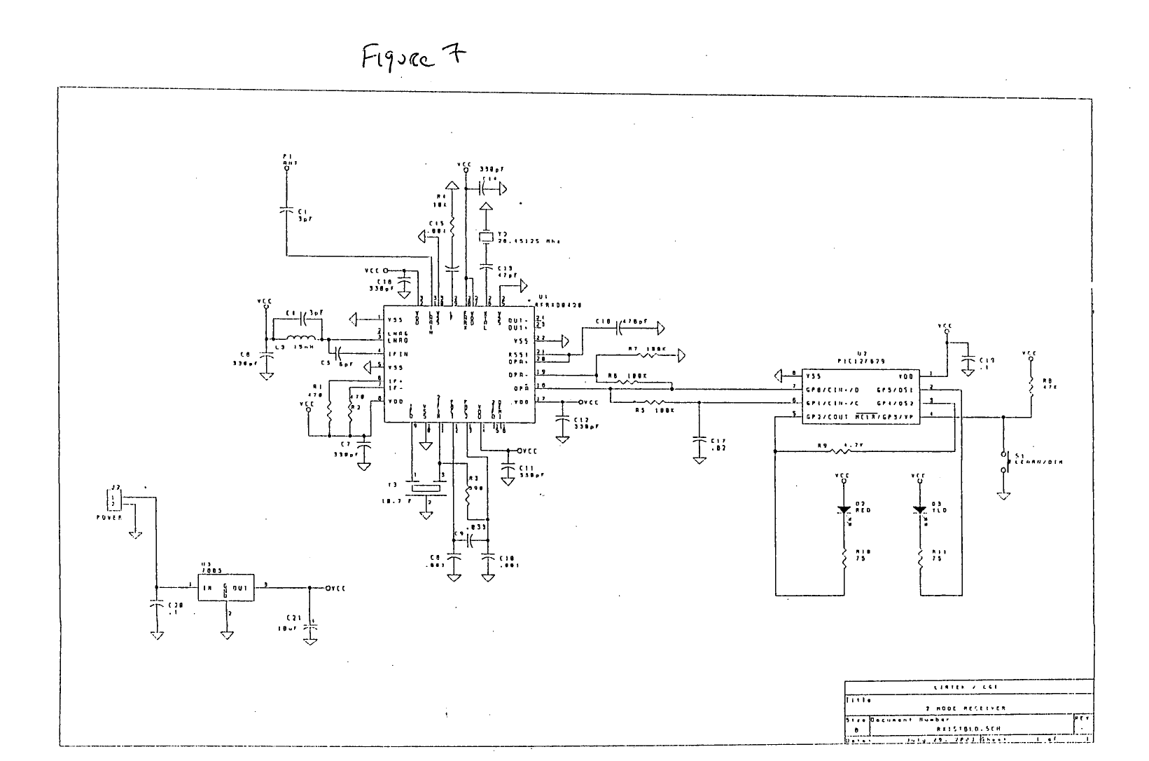

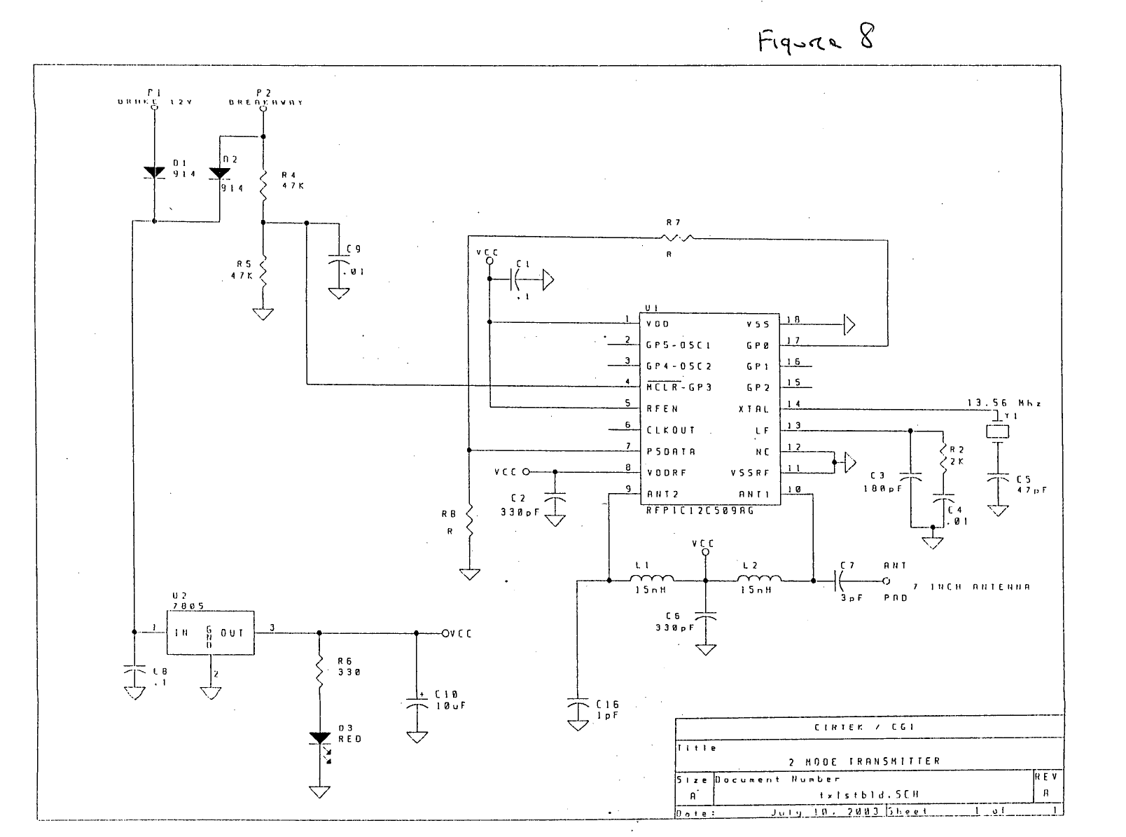

It is understood that transceivers 602, 618 and 642 may be any suitable RF communication device. Accordingly, transceivers, transmitters and/or receivers may be employed by embodiments of the present invention. For convenience, a detailed explanation of RF transceiver operation and construction are not provided herein since it is understood that any suitable RF transceiver, transmitter and/or receiver now known or later developed may be employed by embodiments of the present invention. However, circuit diagrams for one suitable receiver and one suitable transmitter are illustrated in FIGS. 7 and 8, respectively.

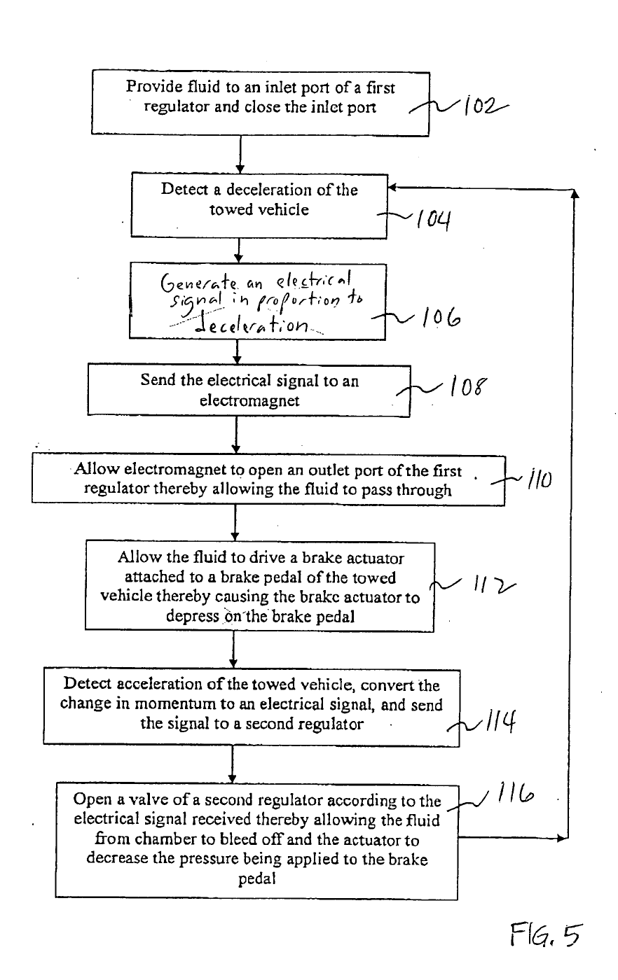

Referring now to FIGS. 2 and 5, in one embodiment, ABD 20 operates in the following manner. At step 102, when cigarette lighter adaptor 42 is connected to the towed vehicle's battery (not shown), air compressor 60 is turned on. Air compressor 60 may then generate and supply fluid, e.g. air, to fluid reservoir 54 via a first fluid connector 63. Air from fluid reservoir 54 is carried through a second fluid connector 67 leading to input port 52 of first regulator 46. In at least one embodiment, input port 52 allows air to be supplied to fluid reservoir 54 at a constant pressure, such as, but not limited to, approximately 27 psi. Input port 52 closes once the constant pressure in fluid reservoir 54 is achieved.

At step 104, controller 44 detects deceleration of the towed vehicle. At step 106, controller 44 converts the a change in the momentum of the inertial sensor, which may be correlated to the momentum change of towed vehicle 22, and generates an electrical signal proportional to the change in momentum. The electrical signal is of a particular unit, which is preferably in voltage, though any suitable signal such as a current or a digital signal is employed in alternative embodiments. At step 108, controller 44 may communicate the electrical signal through an electrical wire to first regulator 46. The electrical signal provides power to electromagnetic coil 90 (shown in FIG. 3B) of first regulator 46 and powers valve actuator member 80 (shown in FIG. 3B). At step 110, valve actuator member 80 causes a valve control mechanism, such as plunger 89 (FIG. 3A), to move from a position blocking the air passage between input port 52 and output port 56 to a position that allows air to pass through the passage and exit through outlet port 56. Other embodiments communicate other suitable forms of signals corresponding to a sensed inertial change via any suitable communication medium, including, but not limited to, radio frequency, infrared, laser or visible light.

At step 112, air exiting through outlet port 56 is carried to fluid chamber 58 and causes an increase in the existing pressure in fluid chamber 58. The increase in fluid pressure drives shaft 62 of brake actuator 30 away from fluid chamber 58. Brake actuator shaft 62, which is configured to be coupled to towed vehicle's 22 brake pedal 26 (FIG. 1), consequently depresses brake pedal 26 thereby causing towed vehicle 22 to slow down or stop.

At step 114, when towing vehicle accelerates again, controller 44 positioned within towed vehicle 22 may detect the acceleration. Controller 44 may correlate this to the change in momentum caused by the acceleration and generates a corresponding electrical signal and communicates the electrical signal to second regulator 73. Second regulator 73 may be coupled to fluid chamber 58 via a fourth fluid connector 71. At step 116, an electrical signal may cause an exhaust valve at a vent port 81 of second regulator 78 to open, thereby allowing air to vent out or bleed. When air vents out, a decrease in air pressure within fluid chamber 58 occurs. The decrease in air pressure and the 7 psi of pressure controlled by second regulator 73 allows brake actuator shaft 62 to move toward fluid chamber head 65. When brake actuator shaft 62 moves toward fluid chamber head 65, the pressure applied by brake actuator shaft 62 to brake pedal 26 of towed vehicle 22 is reduced thereby allowing towed vehicle 22 to accelerate along with towing vehicle 22.

With reference to FIG. 9, one embodiment of controller 44, generally indicated by reference numeral 700 is now described. Controller 44 is shown with an accelerometer 706, a microprocessor 712, an operational amplifier 716, switches 720 and 721, and two panels of LEDs 724, 726. These components are arranged on, or operatively connected to, a printed circuit board.

Controller 44 may be provided with a number of switches 720, 721, 722 by which a user may provide input to controller 44. One switch may be provided to generally refer to the maximum brake pressure button 35. One switch may be provided to generally refer to the brake sensitivity button 37. One switch may be provide to generally refers to the test button 33. In conjunction with switches 720 and 721 are two panels 724, 726 of four LEDs each which generally reference the set of maximum brake pressure lights 39 and the set of brake sensitivity lights 41.

Switches 720 and 721 may be used to set a threshold level of duration and/or intensity of deceleration needed to activate ABD 20. Switches 720 and 721 may also be used to control the rate at which braking force is increased. In at least one embodiment, a user is capable of setting the sensitivity of a plurality, such as four, settings. Each time the user presses a switch, the sensitivity setting may increment to the next highest setting. When the highest setting is reach, additional activations of the switch may cause the controller 44 to cycle or wrap back to the lowest sensitivity setting.

The accelerometer 706 may be a model ADXL 311 accelerometer available from Analogue Devices, Inc. As shown in FIG. 9, the accelerometer 706 is supplied with a voltage V1 and has a quiescent output of one-half V1. When the accelerometer 706 detects a deceleration, the output increases, such as by about 200 millivolts. The accelerometer 706 may be in communication with an operational amplifier 716 a model U-3. The operational amplifier 716 may be used to scale the output from the accelerometer such that 1 g (1 times the force of gravity) of deceleration will provide full scale input to an analog to digital converter in the microprocessor.

Microprocessor 712 may be provided with algorithms that use the sensitivity and force settings, as well as the rate of deceleration determined by accelerometer 706, to generate a pulse width modulated signal. The signal may be used to provide a variable voltage to electromagnetic coil 90 (FIGS. 2, 3A, and 3B). The strength of the signal determines how much force is applied to brake pedal 26 of towed vehicle 22 (FIG. 1).

A delay time factor may be used to help prevent false triggers of ABD 20, for example, going over a railroad track. The delay time factor may require accelerometer 706 to sense the deceleration of a threshold amount for a certain time period before transmitting signals to activate ABD 20. This delay time factor may be the same for all sensitivity settings, or may be appropriately adjusted for different levels of sensitivity-for example, higher levels of sensitivity may have a smaller delay time factor.

Switches 720 and 721 may determine the amount of force that may be applied to brake pedal 26 of towed vehicle 22, and the maximum braking force for each level of sensitivity. The pressure level may be set by the user in a similar manner to the sensitivity level. The pressure level may be controlled by adjusting the amount of voltage applied to electromagnetic coil 90.

In at least one embodiment, when the sensitivity setting is set by the user at a relatively low setting, controller 44 will automatically increase the maximum force that will be applied. In this way, ABD 20 applies a stronger force to brake pedal 26 of towed vehicle 22 to compensate for brake pedal 26 not being activated as quickly as when the sensitivity threshold is reduced.

In certain situations, it may be desirable to temporarily override the user defined force setting. For example, sudden drastic changes in velocity may require braking forces that exceed the user's set pressure level. In this case, controller 44 may be set to monitor the change in gravity (g-force) over time. If the change is excessive, more than would occur during a normal, gradual change in velocity, ABD 20 may be allowed to apply the maximum braking force it is capable of, regardless of the pressure setting.

Controller 44 may be provided with a calibration of the level feature in order to improve the accuracy of the accelerometer. The calibration routine may be activated by the user, such as when the user activates both switches 720, 721 at the same time. Activation of the calibration feature allows the unit to determine a slope value and add it to a table of stored values.

In certain embodiments, controller 44 is configured to periodically check the battery level of towed vehicle 22. If the battery level falls below a certain level, such as 10.5 volts, a warning signal may be transmitted to receiver unit 11 (FIG. 1), which causes an LED to flash. The warning signal could be communicated to the operator by the activation of a specific indicator (e.g., the flashing of the light 624 every five seconds) or other suitable means to alert the operator to the low battery condition. In certain embodiments, ABD 20 may be disabled if the battery falls below a certain threshold, such as 9 volts.

Controller 44 may also be provided with a test feature in order to assure the user that the components of controller 44 are functioning properly. When the test function is activated, such as by a switch or a combination of switches, an output of about 200 millivolts may be sent from the accelerometer to be processed by the electronics of ABS 10, including controller 44. If the unit is functioning properly, the user will observe braking and control signals. In another embodiment, the testing may be initiated by the driver by pressing down on brake pedal 26, and holding brake pedal 26 in the down position until lamp 624 remains illuminated. Lamp 624 remains illuminated until released. Testing the operation of components in the ABD 20 may also be initiated at power up. Those of skill in the art will recognize that the above functions may be implemented in a variety of ways.

It can thus be appreciated that certain embodiments of ABD 20 provide an auxiliary braking system 10 for a towed vehicle 22 that is reactive to the speed of the towing vehicle 24. Certain embodiments of ABD 20 have the ability to depress the brake pedal 26 of the towed vehicle 22 using a pressure that is substantially proportional to the detected change in momentum caused by the deceleration and acceleration of the towing vehicle 24. In doing so, the towing vehicle 24 benefits by virtue of the towed vehicle's brakes relieving the towing vehicle's brakes from excessive wear.

The towed vehicle 22 also benefits by having an auxiliary braking system 10 that activates the towed vehicle's brakes with only the necessary pressure required to slow down the towed vehicle 22. The towed vehicle 22 further benefits from the ABD's 20 quick retraction system, which quickly allows the towed vehicle 22 to accelerate with the towing vehicle 24. Thus, the likelihood of the ABD 20 to constantly depress or “ride” on the towed vehicle's brakes while being accelerated by the towing vehicle 24 is minimized. The likelihood of the towed vehicle's brakes to overheat is consequently minimized.

It can also be appreciated that certain embodiments of ABD 20 provide a portable auxiliary braking device 20 that may be used for any vehicle type. Alternative embodiments provide: an auxiliary braking device 20 that works with vehicles having an ABS system, an auxiliary braking device that does not require tapping into the brake lines of the towed vehicle, an auxiliary braking device that can easily be set-up and operated, and an auxiliary braking device that does not void the towed vehicle's manufacturer's warranty.

In certain embodiments, the present invention provides a brake monitoring system. The brake monitoring system may provide feedback to the driver of a towing vehicle that the braking system of the towed vehicle is properly functioning. In addition, the brake monitoring system may alert the driver to problems with the brake system of the towed vehicle.

### CONCLUSION

Although the description above contains many specifications, these should not be construed as limiting the scope of the invention but as merely providing illustrations of some of presently preferred embodiments of this invention. Thus, the scope of the invention should be determined by the appended claims and their legal equivalents rather than by the examples given.

1) A brake monitoring system comprising:
A) a towing vehicle;
B) a primary braking system in the towing vehicle, the primary braking system comprising a brake pedal, the primary braking system being activatable by depressing the brake pedal;
C) a towed vehicle releasably attached to the towing vehicle;
D) a towed vehicle braking system;
E) an auxiliary braking device configured to activate the towed vehicle braking system;
F) a transmitter unit comprising a transmitter in communication with the auxiliary braking device, the transmitter configured to generate and send a signal when the auxiliary braking device has activated the towed vehicle braking system; and
G) a receiver unit located in the towing vehicle, the receiver unit comprising a receiver configured to receive the signal from the transmitter.

2) The system of claim 1, further comprising an indicator in the towing vehicle, the indicator in communication with the receiver unit and configured to provide positive feedback to a driver of the towing vehicle that the auxiliary braking device has been activated.

3) The system of claim 2, wherein the indicator comprises a lamp that is illuminated when the auxiliary braking device has been activated.

4) The system of claim 1 wherein the signal generated by the transmitter and received by the receiver, comprises a radio frequency signal.

5) The system of claim 1 wherein the transmitter and the receiver are electrically coupled to each other.

6) The system of claim 5 wherein the transmitter and receiver are electrically coupled to each other by at least one wire, wherein the signal from the transmitter is communicated to the receiver over the wire.

7) The system of claim 1 wherein the signal transmitted by the transmitter comprises an identifier, the identifier serving to identify the transmitter.

8) The system of claim 7 wherein the receiver unit comprises a memory, the memory adapted to store at least one identifier, and wherein the receiver unit processes the signal if the signal identifier and the stored at least one identifier correspond.

9) The system of claim 1 wherein the receiver unit comprises a memory configured to store at least one identifier, and wherein the receiver unit generates a signal when it receives the transmitter signal corresponding to the at least one identifier stored in the memory.

10) The system of claim 1 the transmitter unit comprising a processor, the processor configured to carry out a self test when power is supplied to the transmitter unit.

11) The system of claim 10 wherein the self test is initiated when the transmitter unit receives input from an operator.

12) The system of claim 1 wherein the receiver unit comprises a memory, the memory adapted to store at least one identifier, wherein old identifiers can be removed from the memory and new identifiers may be added to the memory.

13) The system of claim 12 wherein the receiver unit activates an indicator when the memory is devoid of identifiers.

14) The system of claim 12 wherein the memory may store a plurality of identifiers associated with more than one transmitter.

15) The system of claim 12, wherein a user may direct the memory to erase the at least one identifier.

16) The system of claim 12, wherein a user may direct the memory to store at least a second identifier.

17) The system of claim 12 further comprising an input device, wherein a user can program the memory using the input device.

18) A method of monitoring a braking system comprising, but not necessarily in the order shown:
A) braking a towing vehicle;
B) activating a braking system in a towed vehicle;
C) transmitting a signal from a transmitter in a transmitter unit in the towed vehicle, the signal indicating that the braking system in the towed vehicle has been activated;
D) receiving the signal by a receiver in a receiver unit in the towing vehicle; and
E) indicating to a driver of the towing vehicle that the braking system in the towed vehicle has been activated.

19) The method of claim 18, further comprising activating an indicator when the signal is received by the receiver.

20) The method of claim 19, wherein the indicator comprises a light.

21) The method of claim 20, further comprising activating a dimming actuator, the dimming actuator controlling an illumination level of the light.

22) The method of claim 18, wherein the transmitted signal comprises a radio frequency transmission.

23) The method of claim 18 further comprising including an identifier in the signal, wherein the identifier identifies the transmitter.

24) The method of claim 23, further comprising storing a first identifier in a memory in the receiver unit.

25) The method of claim 24, further comprising storing a second identifier in the memory.

26) The method of claim 23, further comprising erasing the identifier from a memory in the receiver unit.

27) The method of claim 18 further comprising:
A) providing power to the transmitter unit; and
B) performing a self test by the transmitter unit.

28) The method of claim 18 further comprising performing a self test by the transmitter unit when directed by a user.

29) The method of claim 18, further comprising indicating to the driver that an improper condition has occurred in the towed or towing vehicle.

30) A brake monitoring system comprising:
A) an auxiliary braking device, the auxiliary braking device configured to activate a braking system of a towed vehicle;
B) a transmitter unit comprising a transmitter, the transmitter configured to transmit a signal indicating that the braking system of the towed vehicle has been activated;
C) a receiver unit comprising a receiver, the receiver configured to receive the signal transmitted by the transmitter; and
D) an indicator, the indicator in communication with the receiver unit, wherein activation of the indicator informs a driver of a towing vehicle that the braking system of the towed vehicle has been activated.

31) The monitoring system of claim 30, wherein the indicator comprises a light that is illuminated when activated by the receiver unit when the receiver receives the signal from the transmitter.

32) The monitoring system of claim 31 wherein the light may be illuminated at least at a first and a second illumination level, and further comprising a dimming actuator, wherein the dimming actuator directs the light to illuminate at either the first or the second illumination level.

33) The monitoring system of claim 30, wherein the signal transmitted by the transmitter comprises an identifier, the receiver unit comprises a memory adapted to store at least one identifier, and wherein the receiver unit compares the transmitted identifier to the stored identifier and activates the indicator only if the compared identifiers correspond.

34) The monitoring system of claim 30 further comprising a processor, the processor configured to perform a self test and ensure that the transmitter unit is operating properly.

35) A device for monitoring a supplemental braking system comprising:
A) supplemental braking means for decelerating a towed vehicle;
B) transmitter means for transmitting a signal when the supplemental braking means has been activated;
C) receiver means for receiving the signal from the transmitter means; and
D) indicator means for indicating to an occupant of a towing vehicle that the supplemental braking means has been activated.

36) The method of claim 35 wherein the signal comprises identifier means for identifying the transmitter means.

37) The method of claim 36, wherein the receiver means comprises storage means for storing at least one identifier.

38) The method of claim 35 wherein the transmitter means comprises processor means for performing a self test.
